(19) United States
(12) Patent Application Publication
(10) Pub. No.: US 2024/0388038 A1
(43) Pub. Date: Nov. 21, 2024

(54) Connector Structure, Fitting Position Guarantee Lock, And First Connector

(71) Applicant: Yazaki Corporation, Tokyo (JP)

(72) Inventors: Motoyoshi Suzuki, Shizuoka (JP); Tomoyoshi Fukaya, Shizouka (JP); Yukihiro Takagi, Tokyo (JP)

(21) Appl. No.: 18/642,087

(22) Filed: Apr. 22, 2024

(30) Foreign Application Priority Data
May 17, 2023 (JP) 2023-081737

(51) Int. Cl. H01R 13/641; H01R 13/627

(52) U.S. Cl. CPC H01R 13/641; H01R 13/6272

(57) ABSTRACT

A connector structure includes a first connector, a second connector configured to be fitted with the first connector, and a fitting position guarantee lock attached to the second connector in a manner of being slidable in a fitting direction of the first connector and the second connector. The fitting position guarantee lock includes a second arm whose distal end is flexible in a protrusion direction, a fourth locking portion provided at the distal end of the second arm and configured to ride over a third locking portion and to be engaged with the third locking portion, a third arm whose distal end is flexible in the protrusion direction, and a fifth locking portion provided at the distal end of the third arm and configured to ride over the second locking portion and to be engaged with the second locking portion at a final locking position.

### CROSS-REFERENCE TO RELATED APPLICATIONS

This application is based on and claims priority under 35 USC 119 from Japanese Patent Application No. 2023-081737 filed on May 17, 2023, the contents of which are incorporated herein by reference.

### TECHNICAL FIELD

The present disclosure relates to a connector structure, a fitting position guarantee lock, and a first connector.

### BACKGROUND ART

As a connector structure in the related art, a half-fitting prevention connector described in JP2012-064461A has been proposed. The half-fitting prevention connector in JP2012-064461A includes a male connector, a female connector fitted in the male connector, and a fitting position guarantee lock (CPA) slidably attached to the female connector. The fitting position guarantee lock cannot be moved from the temporary locking position to the final locking position when the male connector and the female connector are half-fitted.

In the half-fitting prevention connector in the related art described above, since the male connector, the female connector, and the CPA have large backlash after the connectors are fitted, the sliding friction of a terminal contact point portion is large, and there is a concern of poor electrical continuity.

The present disclosure has been made in view of the above circumstances, and an object of the present disclosure is to provide a connector structure, a fitting position guarantee lock, and a first connector in which backlash is reduced.

### SUMMARY OF INVENTION

According to the present disclosure, a connector structure includes a first connector, a second connector configured to be fitted with the first connector, and a fitting position guarantee lock attached to the second connector in a manner of being slidable in a fitting direction of the first connector and the second connector. The first connector includes a first locking portion and a second locking portion that protrude to both sides in a protrusion direction intersecting the fitting direction. The second connector includes a first arm whose distal end is flexible in the protrusion direction, and a third locking portion provided at the distal end of the first arm and configured to ride over the first locking portion and to be engaged with the first locking portion when the first connector and the second connector are fitted to each other. The fitting position guarantee lock includes a second arm whose distal end is flexible in the protrusion direction, a fourth locking portion provided at the distal end of the second arm and configured to ride over the third locking portion and to be engaged with the third locking portion after the third locking portion rides over the first locking portion and is engaged with the first locking portion, a third arm whose distal end is flexible in the protrusion direction, and a fifth locking portion provided at the distal end of the third arm and configured to ride over the second locking portion and to be engaged with the second locking portion at a final locking position where the fourth locking portion rides over the third locking portion and is engaged with the third locking portion.

According to the present disclosure, a fitting position guarantee lock attached to a second connector in a manner of being slidable in a fitting direction of a first connector and the second connector, the fitting position guarantee lock includes a second arm whose distal end is flexible in a protrusion direction intersecting the fitting direction, a fourth locking portion provided at the distal end of the second arm, and configured to, after a third locking portion provided at a distal end of a first arm that is flexible in the protrusion direction of the second connector rides over a first locking portion protruding toward one side in the protrusion direction of the first connector and is engaged with the first locking portion, ride over the third locking portion and be engaged with the third locking portion, a third arm whose distal end is flexible in the protrusion direction, and a fifth locking portion provided at the distal end of the third arm, and configured to ride over a second locking portion protruding toward the other side in the protrusion direction of the first connector and to be engaged with the second locking portion at a final locking position where the fourth locking portion rides over the third locking portion and is engaged with the third locking portion.

According to the present disclosure, a first connector to be fitted with a second connector to which a fitting position guarantee lock is slidably attached, the first connector includes a first locking portion and a second locking portion protruding to both sides in a protrusion direction intersecting a fitting direction of the first connector and the second connector, and configured to be engaged with a locking portion that is provided at a distal end of a flexible arm in the protrusion direction of the fitting position guarantee lock slidably attached to the second connector.

The present disclosure has been briefly described above. Further, the details of the present disclosure can be clarified by reading modes (hereinafter, referred to as “embodiments”) for carrying out the disclosure described below with reference to the accompanying drawings.

### BRIEF DESCRIPTION OF DRAWINGS

FIG. 1 is a longitudinal cross-sectional view showing a connector structure according to an embodiment of the present disclosure before fitting;

FIG. 2 is a perspective view of a male connector shown in FIG. 1;

FIG. 3 is a perspective view of a female connector and a CPA shown in FIG. 1;

FIG. 4 is a cross-sectional view taken along a line A-A in FIG. 1;

FIG. 5 is a perspective view of the CPA shown in FIG. 1;

FIG. 6 is an enlarged view of a portion B in FIG. 5;

FIG. 7 is a longitudinal cross-sectional view of the female connector and the male connector shown in FIG. 1 in the middle of being fitted together;

FIG. 8 is a longitudinal cross-sectional view of the connector structure shown in FIG. 1 after fitting and when the CPA is in the middle of moving to the final locking position;

FIG. 9 is a longitudinal cross-sectional view of a male housing rib and the vicinity of a rib insertion groove in the connector structure shown in FIG. 8;

FIG. 10 is an enlarged view of a portion C in FIG. 9;

FIG. 11 is a longitudinal cross-sectional view of the connector structure shown in FIG. 1 after fitting and after the CPA moves to the final locking position;

FIG. 12 is a longitudinal cross-sectional view of the male housing rib and the rib insertion groove in the connector structure shown in FIG. 11; and

FIG. 13 is an enlarged view of a portion D in FIG. 12.

### DESCRIPTION OF EMBODIMENTS

A specific embodiment of the present disclosure will be described below with reference to the drawings.

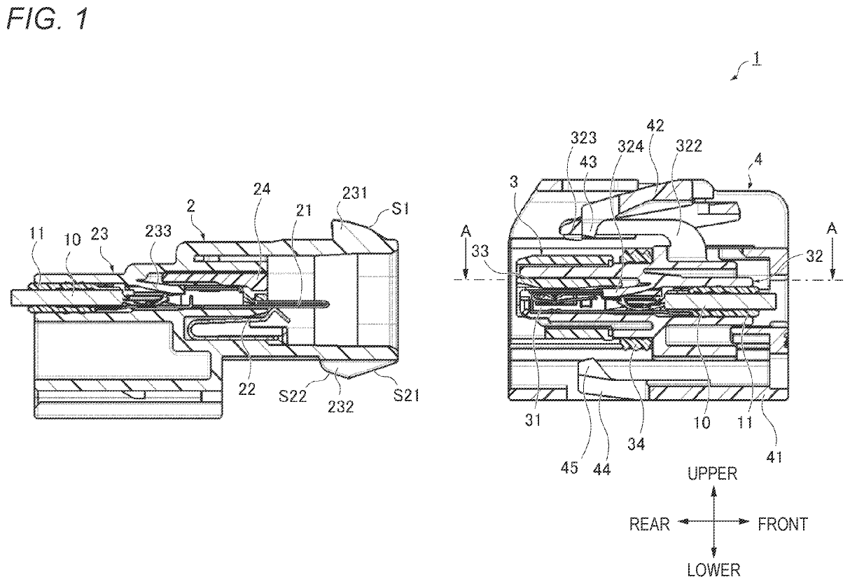

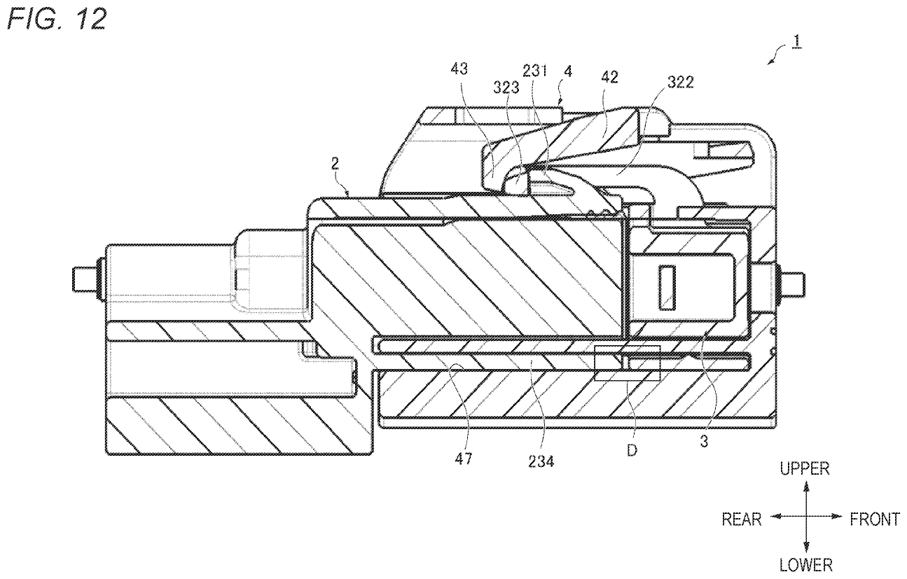

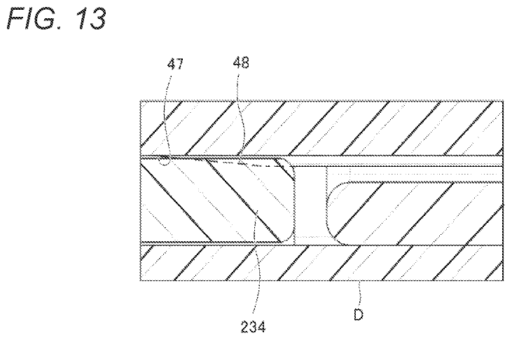

Hereinafter, for convenience of description, as shown in FIGS. 1 to 13, “front”, “rear”, “left”, “right”, “upper”, and “lower” are defined. The “front-rear direction”, the “left-right direction”, and the “upper-lower direction” are orthogonal to one another. The front-rear direction corresponds to the “fitting direction” according to the present disclosure. The upper-lower direction corresponds to the “protrusion direction” according to the present disclosure.

As shown in FIG. 1, a connector structure 1 according to the present embodiment includes a male connector 2 (a first connector), a female connector 3 to be fitted to the male connector 2, and a fitting position guarantee lock (CPA) 4 attached to the outside of the female connector 3 in a manner of being slidable in the front-rear direction.

The male connector 2 includes two male terminals 21, a short spring 22 that comes into contact with the two male terminals 21, a male housing 23 that houses the male terminals 21 and the short spring 22, and a male front retainer 24.

The male terminal 21 is provided by punching out and bending a conductive metal plate. The male terminal 21 is housed in the male housing 23 such that the longitudinal direction is along the front-rear direction. The two male terminals 21 are housed in the male housing 23 side by side in the left-right direction. The male terminal 21 is attached to the end of an electric wire 10. A rubber plug 11 is externally fitted to the end of the electric wire 10, and the portion to which the rubber plug 11 is externally fitted is housed in the male housing 23.

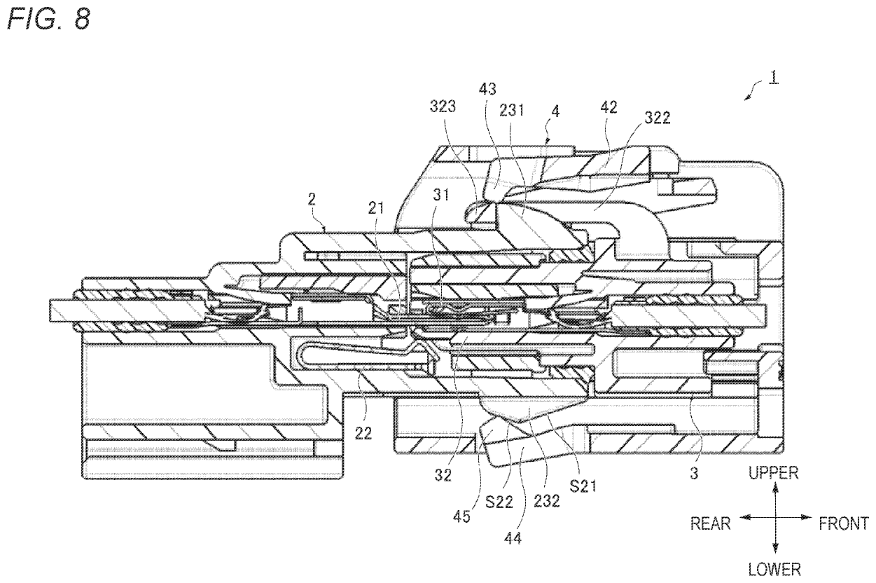

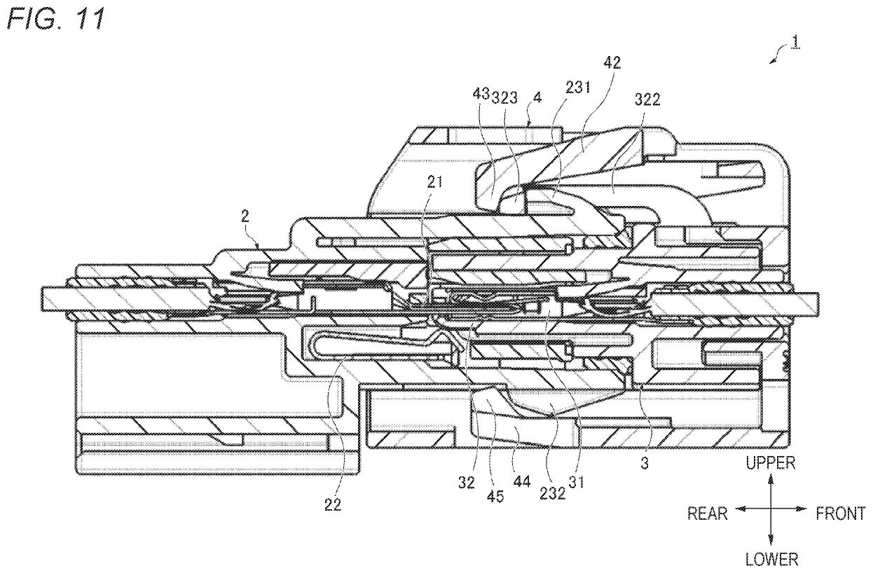

The short spring 22 is provided by punching out and bending a conductive metal plate. As shown in FIG. 1, in a state in which the male connector 2 and the female connector 3 are not fitted to each other, the short spring 22 comes into contact with the male terminals 21 and short-circuits the two male terminals 21. On the other hand, as shown in FIGS. 8 and 11, in a state in which the male connector 2 and the female connector 3 are fitted to each other, the connection between the short spring 22 and the male terminal 21 is released by inserting a female housing 32 between the short spring 22 and the male terminal 21.

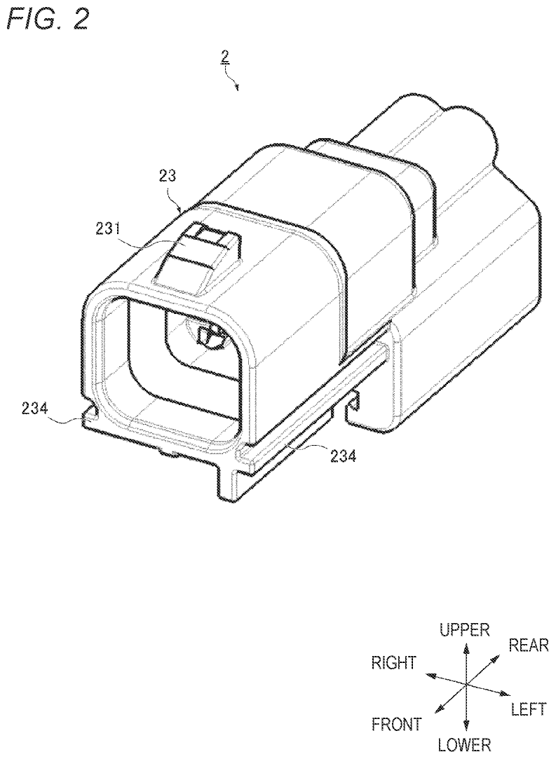

The male housing 23 is made of an insulating member such as resin. As shown in FIG. 1, the male housing 23 includes an upper lock beak 231 (a first locking portion), a lower lock beak 232 (a second locking portion), a male housing lance 233, and a pair of male housing ribs 234 and 234 (first ribs; see FIG. 2). As shown in FIG. 1, the upper lock beak 231 and the lower lock beak 232 protrude from the outer side surface of the cylindrical male housing 23 to both sides in the upper-lower direction. The upper lock beak 231 protrudes upward, and is engaged with the upper lock beak 323 of the female connector 3 to be described later. The upper lock beak 231 is provided with an inclined surface S1 whose protrusion height increases toward the rear side at the front end portion.

The lower lock beak 232 protrudes downward, and is engaged with a lower lock beak 45 of the CPA 4 to be described later. The lower lock beak 232 is provided with an inclined surface S21 (a first inclined surface) whose protrusion height increases toward the rear side at the front end portion, and an inclined surface S22 (a second inclined surface) that is adjacent to the rear side of the inclined surface S21 and whose protrusion height decreases toward the rear side. The male housing lance 233 protrudes forward and downward from the inner side surface of the cylindrical male housing 23, and is engaged with the male terminal 21.

As shown in FIG. 2, the pair of male housing ribs 234 and 234 protrude from the outer side surface of the male housing 23 to both sides in the left-right direction. The pair of male housing ribs 234 and 234 extend in the front-rear direction and are provided from the front end of the male housing 23 to the middle in the front-rear direction.

As shown in FIG. 1, the female connector 3 includes two female terminals 31 electrically connected to the two male terminals 21, the female housing 32 that houses the two female terminals 31, and a female front retainer 33 and a packing 34 that are externally fitted to the female housing 32.

The female terminal 31 is provided by punching out and bending a conductive metal plate. The female terminal 31 is housed in the female housing 32 such that the longitudinal direction is along the front-rear direction. The two female terminals 31 are housed in the female housing 32 side by side in the left-right direction. The end of the electric wire 10 is attached to the female terminal 31. The rubber plug 11 is externally fitted to the end of the electric wire 10, and the portion to which the rubber plug 11 is externally fitted is inserted into the female housing 32.

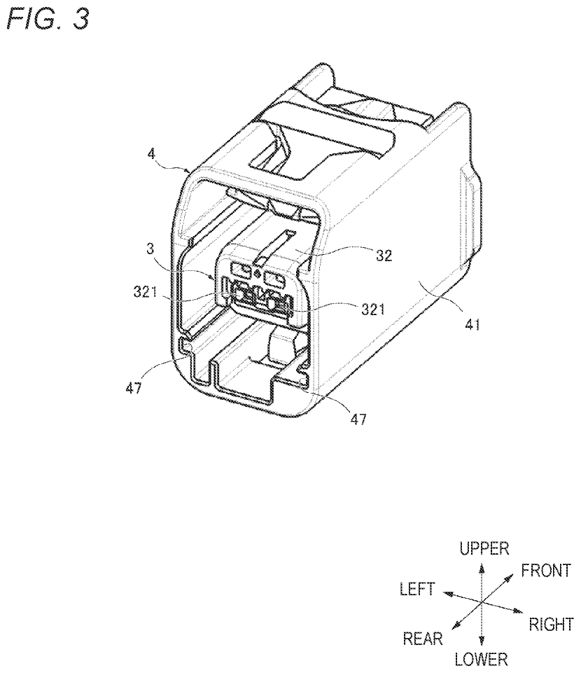

The female housing 32 is made of an insulating member such as resin. As shown in FIG. 3, the female housing 32 includes two terminal accommodating chambers 321. The two terminal accommodating chambers 321 are arranged side by side in the left-right direction, and the female terminals 31 are accommodated one by one.

As shown in FIG. 1, the female housing 32 includes a pair of lock arms 322 and 322 (first arms), an upper lock beak 323 (a third locking portion), and a female housing lance 324. The pair of lock arms 322 and 322 protrude upward from the upper outer side surface of the female housing 32, extend toward the rear side (the male connector 2 side), and include rear ends (distal ends) that are flexible in the upper-lower direction. The pair of lock arms 322 and 322 are arranged side by side in the left-right direction. The upper lock beak 323 connects the rear ends of the pair of lock arms 322 and 322.

The female housing lance 324 protrudes rearward and downward in the terminal accommodating chamber 321, and is engaged with the female terminal 31.

The female front retainer 33 is made of an insulating member such as resin. The female front retainer 33 is inserted from the rear side of the female housing 32 and is partially accommodated in the terminal accommodating chamber 321. The female front retainer 33 accommodated in the terminal accommodating chamber 321 is inserted between the distal end of the female housing lance 324 and the inner side surface of the terminal accommodating chamber 321. Accordingly, the distal end of the female housing lance 324 is bent toward the inner side surface of the terminal accommodating chamber 321 to prevent the female housing lance 324 from being disengaged from the female terminal 31.

The packing 34 is externally fitted into the female housing 32 on the front side with respect to the female front retainer 33.

The CPA 4 is attached to the female connector 3 in a manner of being slidable in the front-rear direction. The CPA includes a substantially rectangular cylindrical housing 41 that houses the female connector 3, an upper lock arm 42 (a second arm), an upper lock beak 43 (a fourth locking portion), a lower lock arm 44 (a third arm), and a lower lock beak 45 (a fifth locking portion).

The upper lock arm 42 extends rearward and downward from the upper side in the housing 41, and includes a rear end (a distal end) that is flexible in the upper-lower direction. The upper lock beak 43 protruding downward is provided at the rear end of the upper lock arm 42. The lower lock arm 44 extends rearward and upward from the lower side in the housing 41, and includes a rear end (a distal end) that is flexible in the upper-lower direction. The lower lock beak 45 protruding upward is provided at the rear end of the lower lock arm 44.

The CPA 4 is slidable between the final locking position (see FIG. 11) at which the upper lock beak 43 is located on the rear side with respect to the upper lock beak 323 of the female connector 3 and the temporary locking position (see FIG. 1) at which the upper lock beak 43 is located on the front side with respect to the upper lock beak 323 of the female connector 3.

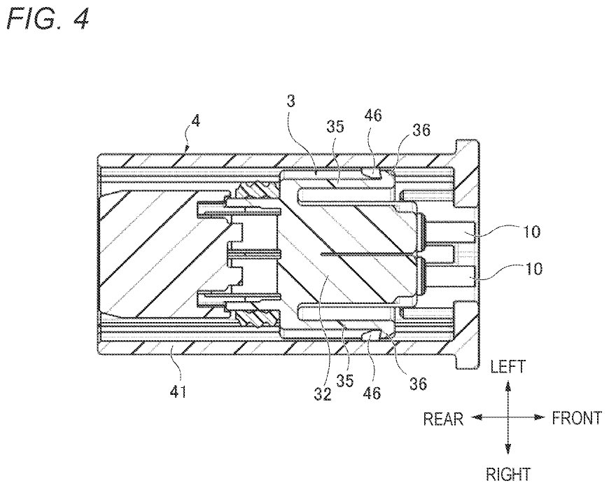

As shown in FIG. 4, the female connector 3 includes a pair of lock arms 35 and 35 and a pair of female housing side locks 36 and 36. The CPA 4 includes a pair of CPA side locks 46 and 46. The pair of lock arms 35 and 35 extend forward from the left and right outer side surfaces of the female housing 32, and include front ends that are flexible in the left-right direction. The pair of female housing side locks 36 and 36 protruding outward in the left-right direction are provided at the front ends of the pair of lock arms 35 and 35. The CPA side lock 46 protrudes from the left and right inner side surfaces of the housing 41. When the CPA 4 is at the temporary locking position, the female housing side lock 36 and the CPA side lock 46 are engaged to prevent the female connector 3 from falling off from the CPA 4.

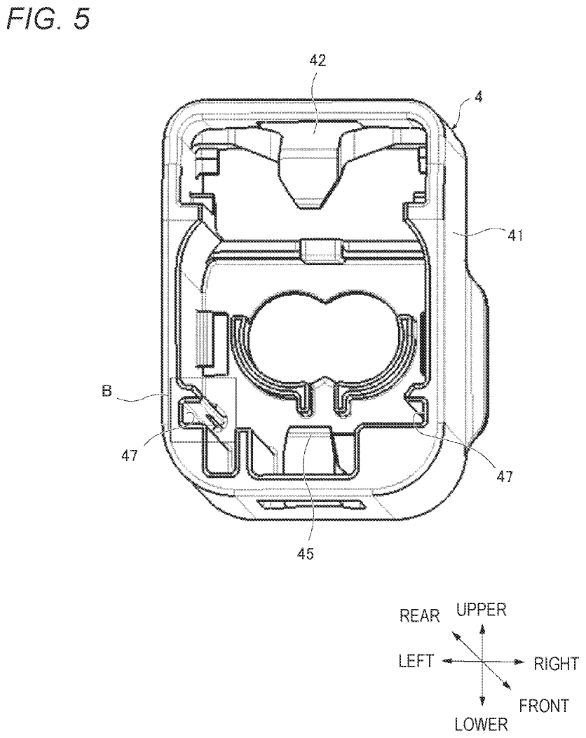

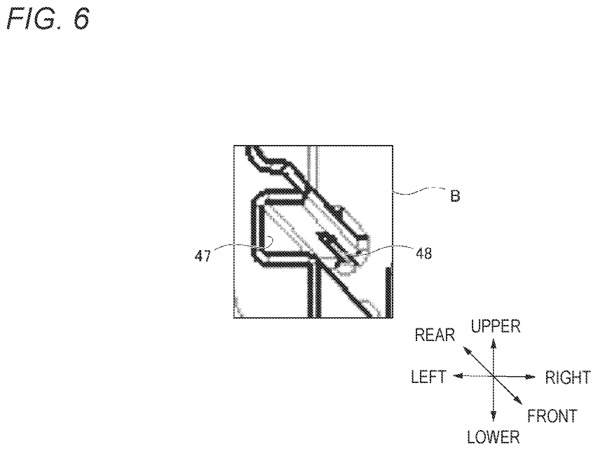

As shown in FIGS. 5 and 6, the CPA 4 includes a pair of rib insertion grooves 47 and 47 and a pair of crush ribs 48 and 48 (second ribs).

As shown in FIG. 5, the pair of rib insertion grooves 47 and 47 are formed in a concave shape on the left and right inner side surfaces of the housing 41, and the pair of male housing ribs 234 and 234 of the male connector 2 are inserted. The pair of rib insertion grooves 47 and 47 extend in the front-rear direction and are provided from the rear end of the housing 41 to the middle in the front-rear direction.

As shown in FIG. 6, the pair of crush ribs 48 and 48 protrude from the inner side surfaces of the pair of rib insertion grooves 47 and 47. In the present embodiment, the pair of crush ribs 48 and 48 protrude downward. The pair of crush ribs 48 and 48 are not provided on the rear side of the pair of rib insertion grooves 47 and 47, but are provided only on the front end portion. That is, the pair of crush ribs 48 and 48 are not in contact with the male housing rib 234 at the temporary locking position, and are brought into contact with the male housing rib 234 at the final locking position and crushed. The crush rib 48 is provided with an inclined surface whose protrusion height increases toward the front side at the rear end portion.

Next, a procedure for fitting the male connector 2 and the female connector 3 described above will be described. The female connector 3 accommodates the female terminal 31 in the terminal accommodating chamber 321 when the CPA 4 is slid to the rear side and is at the final locking position. After the female terminal 31 is accommodated, as shown in FIG. 1, the male connector 2 and the female connector 3 are fitted to each other in a state in which the CPA 4 is slid to the front side and is at the temporary locking position. Before the male connector 2 and the female connector 3 are fitted to each other, the short spring 22 is in contact with the male terminal 21.

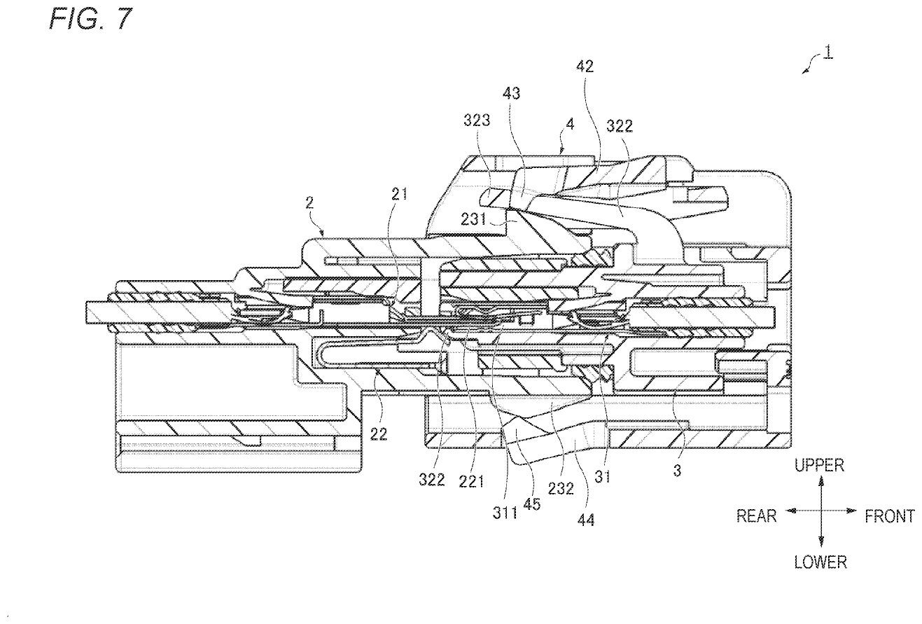

The male connector 2 and the female connector 3 are brought close to each other, and the male connector 2 is inserted into the CPA 4. At this time, the front end of the male housing rib 234 of the male connector 2 is inserted from the rear end of the rib insertion groove 47 of the CPA 4. The male connector 2 is guided in the front-rear direction by the rib insertion groove 47. When the male connector 2 and the female connector 3 are further brought close to each other, as shown in FIG. 7, the rear end of the lock arm 322 of the female connector 3 bends upward, and the upper lock beak 323 rides on the upper lock beak 231 of the male connector 2. The rear end of the upper lock arm 42 of the CPA 4 bends upward, and the upper lock beak 43 rides on the upper lock beak 231 of the male connector 2. Further, the rear end of the lower lock arm 44 of the CPA 4 bends downward, and the lower lock beak 45 rides on the lower lock beak 232 of the male connector 2.

When the male connector 2 and the female connector 3 are further brought close to each other, as shown in FIG. 8, the upper lock beak 323 of the female connector 3 rides over the upper lock beak 231 of the male connector 2. At this time, the rear end of the lock arm 322 of the female connector 3 is restored downward, the upper lock beak 323 is located behind the upper lock beak 231, and the upper lock beak 323 and the upper lock beak 231 are locked. Accordingly, the male connector 2 and the female connector 3 are completely fitted to each other.

When the upper lock beak 323 and the upper lock beak 231 are locked, the upper surfaces of the upper lock beak 231 and the upper lock beak 323 are at the same height.

Therefore, the upper lock beak 43 of the CPA 4 can ride on the upper lock beak 323 of the female connector 3.

When the upper lock beak 323 rides over the upper lock beak 231, the lower lock beak 45 is in contact with the inclined surface S22 of the lower lock beak 232. Therefore, the force of sliding rearward is generated in the CPA 4 due to the action of the force of restoring the rear end of the lower lock arm 44 upward and the inclined surface S22. This force causes the CPA 4 to slide from the temporary locking position toward the final locking position. That is, after the male connector 2 and the female connector 3 are fitted to each other, the CPA 4 can be smoothly moved from the temporary locking position to the final locking position.

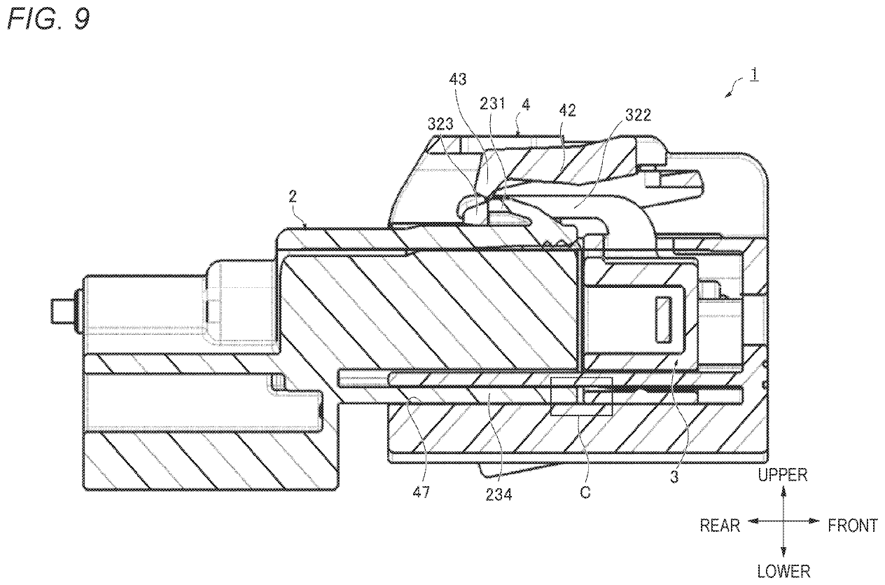

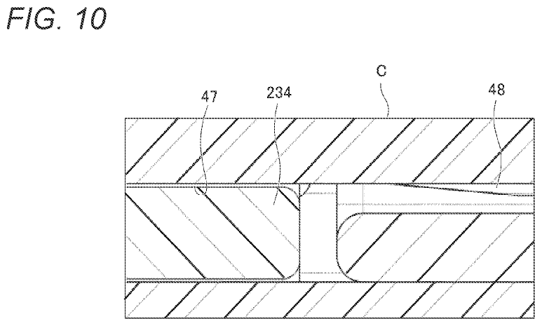

As shown in FIGS. 9 and 10, even after the upper lock beak 323 rides over the

upper lock beak 231 and the male connector 2 and the female connector 3 are fitted to each other, if the CPA 4 is not at the final locking position, the crush rib 48 is not in contact with the male housing rib 234.

As shown in FIG. 11, when the CPA 4 moves to the final locking position, the upper lock beak 43 rides over the upper lock beak 323. At this time, the rear end of the upper lock arm 42 is restored downward, the upper lock beak 43 is located behind the upper lock beak 323, and the upper lock beak 43 and the upper lock beak 323 are locked. Further, the lower lock beak 45 rides over the lower lock beak 232. At this time, the rear end of the lower lock arm 44 is restored upward, the lower lock beak 45 is located behind the lower lock beak 232, and the lower lock beak 45 and the lower lock beak 232 are locked. In the present embodiment, when at the final locking position, the distal ends of the upper lock arm 42 and the lower lock arm 44 remain bent. Therefore, due to the restoring forces of the upper lock arm 42 and the lower lock arm 44, a force that is sandwiched between the male connector 2 and the female connector 3 is generated in the upper-lower direction, and it is possible to reduce backlash of the connector structure 1 in the upper-lower direction.

The female housing 32 is inserted between the male terminal 21 and the short spring 22, and the connection between the male terminal 21 and the short spring 22 is released.

When the CPA 4 moves to the final locking position, the crush rib 48 comes into contact with the male housing rib 234 and is crushed. The crush rib 48 can reduce backlash of the connector structure 1 in the upper-lower direction.

The present disclosure is not limited to the above embodiment, and can be appropriately modified, improved, or the like. In addition, materials, shapes, sizes, numbers, arrangement positions and the like of components in the above embodiments are freely selected and are not limited as long as the present disclosure can be implemented.

For example, according to the above embodiment, the male connector 2 includes the short spring 22. However, the short spring 22 is not essential and may be omitted.

For example, according to the above embodiment, the crush rib 48 is provided. However, the crush rib 48 is not essential and may be omitted.

Here, the features of the embodiment of the connector structure, the fitting position detection lock, and the first connector according to the present disclosure described above are briefly summarized and listed in the following (i) to (v).
(i)

A connector structure (1) including:
a first connector (2);
a second connector (3) configured to be fitted with the first connector (2); and a fitting position guarantee lock (4) attached to the second connector (3) in a manner of being slidable in a fitting direction (a front-rear direction) of the first connector (2) and the second connector (3),
in which the first connector (2) includes a first locking portion (231) and a second locking portion (232) that protrude to both sides in a protrusion direction (an upper-lower direction) intersecting the fitting direction (the front-rear direction),
in which the second connector (3) includes a first arm (322) whose distal end is flexible in the protrusion direction (the upper-lower direction), and a third locking portion (323) provided at the distal end of the first arm (322) and configured to ride over the first locking portion (231) and to be engaged with the first locking portion (231) when the first connector (2) and the second connector (3) are fitted to each other, and
in which the fitting position guarantee lock (4) includes a second arm (42) whose distal end is flexible in the protrusion direction (the upper-lower direction), a fourth locking portion (43) provided at the distal end of the second arm (42) and configured to ride over the third locking portion (323) and to be engaged with the third locking portion (323) after the third locking portion (323) rides over the first locking portion (231) and is engaged with the first locking portion (231), a third arm (44) whose distal end is flexible in the protrusion direction (the upper-lower direction), and a fifth locking portion (45) provided at the distal end of the third arm (44) and configured to ride over the second locking portion (232) and to be engaged with the second locking portion (232) at a final locking position where the fourth locking portion (43) rides over the third locking portion (323) and is engaged with the third locking portion (323).

According to the configuration in the above (i), due to the restoring forces of the second arm (42) and the third arm (44) of the fitting position guarantee lock (4), a force that is sandwiched between the first connector (2) and the second connector (3) is generated in the protrusion direction (the upper-lower direction), and it is possible to reduce backlash of the connector structure (1) in the upper-lower direction.
(ii)

The connector structure (1) according to (i),
in which the second locking portion (232) is provided with a first inclined surface (S21) whose protrusion height increases toward a first connector (2) side in the fitting direction (the front-rear direction), and a second inclined surface (S22) that is adjacent to the first connector (2) side of the first inclined surface (S21) and whose protrusion height decreases toward the first connector (2) side in the fitting direction (the front-rear direction), and
in which, when the third locking portion (323) rides over the first locking portion (231), the fifth locking portion (45) is in contact with the second inclined surface (S22).

According to the configuration in the above (ii), a force of sliding toward the first connector side (rearward) is generated in the fitting position guarantee lock (4) due to the action of the force of restoring the distal end of the third arm (44) and the second inclined surface (S22). Therefore, after the first connector (2) and the second connector (3) are fitted to each other, the fitting position guarantee lock (4) can be smoothly moved from the temporary locking position to the final locking position.
(iii)

The connector structure (1) according to (i),
in which the first connector (2) includes a first rib (234) extending in the fitting direction (the front-rear direction),
in which the fitting position guarantee lock (4) has a rib insertion groove (47) into which the first rib (234) is inserted and that guides the first connector (2) in the fitting direction (the front-rear direction), and
in which a second rib (48) configured to come into contact with the first rib (234) at the final locking position is provided in the rib insertion groove (47).

According to the configuration in the above (iii), the second rib (48) can further reduce the backlash when the fitting position guarantee lock (4) is at the final locking position.
(iv)

A fitting position guarantee lock (4) attached to a second connector (3) in a manner of being slidable in a fitting direction (a front-rear direction) of a first connector (2) and the second connector (3), the fitting position guarantee lock (4) including:
a second arm (42) whose distal end is flexible in a protrusion direction (an upper-lower direction) intersecting the fitting direction (the front-rear direction);
a fourth locking portion (43) provided at the distal end of the second arm (42), and configured to, after a third locking portion (323) provided at a distal end of a first arm (322) that is flexible in the protrusion direction (the upper-lower direction) of the second connector (3) rides over a first locking portion (231) protruding toward one side in the protrusion direction (the upper-lower direction) of the first connector (2) and is engaged with the first locking portion (231), ride over the third locking portion (323) and be engaged with the third locking portion (323);
a third arm (44) whose distal end is flexible in the protrusion direction (the upper-lower direction); and
a fifth locking portion (45) provided at the distal end of the third arm (44), and configured to ride over a second locking portion (232) protruding toward the other side in the protrusion direction (the upper-lower direction) of the first connector (2) and to be engaged with the second locking portion (232) at a final locking position where the fourth locking portion (43) rides over the third locking portion (323) and is engaged with the third locking portion (323).

According to the configuration in the above (iv), due to the restoring forces of the second arm (42) and the third arm (44) of the fitting position guarantee lock (4), a force that is sandwiched between the first connector (2) and the second connector (3) is generated in the protrusion direction (the upper-lower direction), and it is possible to reduce backlash of the connector structure (1) in the upper-lower direction.
(v)

A first connector (2) to be fitted with a second connector (3) to which a fitting position guarantee lock (4) is slidably attached, the first connector (2) including:
a first locking portion (231) and a second locking portion (232) protruding to both sides in a protrusion direction (an upper-lower direction) intersecting a fitting direction (a front-rear direction) of the first connector (2) and the second connector (3), and configured to be engaged with a locking portion that is provided at a distal end of a flexible arm in the protrusion direction (the upper-lower direction) of the fitting position guarantee lock (4) slidably attached to the second connector (3).

According to the configuration in the above (v), due to the restoring forces of the second arm (42) and the third arm (44) of the fitting position guarantee lock (4), a force that is sandwiched between the first connector (2) and the second connector (3) is generated in the protrusion direction (the upper-lower direction), and it is possible to reduce backlash of the connector structure (1) in the upper-lower direction.

What is claimed is:

1. A connector structure comprising:
a first connector;
a second connector configured to be fitted with the first connector; and
a fitting position guarantee lock attached to the second connector in a manner of being slidable in a fitting direction of the first connector and the second connector,
wherein the first connector includes a first locking portion and a second locking portion that protrude to both sides in a protrusion direction intersecting the fitting direction,
wherein the second connector includes:
a first arm whose distal end is flexible in the protrusion direction, and
a third locking portion provided at the distal end of the first arm and configured to ride over the first locking portion and to be engaged with the first locking portion when the first connector and the second connector are fitted to each other, and
wherein the fitting position guarantee lock includes:
a second arm whose distal end is flexible in the protrusion direction,
a fourth locking portion provided at the distal end of the second arm and configured to ride over the third locking portion and to be engaged with the third locking portion after the third locking portion rides over the first locking portion and is engaged with the first locking portion,
a third arm whose distal end is flexible in the protrusion direction, and
a fifth locking portion provided at the distal end of the third arm and configured to ride over the second locking portion and to be engaged with the second locking portion at a final locking position where the fourth locking portion rides over the third locking portion and is engaged with the third locking portion.

2. The connector structure according to claim 1,
wherein the second locking portion is provided with a first inclined surface whose protrusion height increases toward a first connector side in the fitting direction, and a second inclined surface that is adjacent to the first connector side of the first inclined surface and whose protrusion height decreases toward the first connector side in the fitting direction, and
wherein, when the third locking portion rides over the first locking portion, the fifth locking portion is in contact with the second inclined surface.

3. The connector structure according to claim 1,
wherein the first connector includes a first rib extending in the fitting direction,
wherein the fitting position guarantee lock has a rib insertion groove into which the first rib is inserted and that guides the first connector in the fitting direction, and
wherein a second rib configured to come into contact with the first rib at the final locking position is provided in the rib insertion groove.

4. A fitting position guarantee lock attached to a second connector in a manner of being slidable in a fitting direction of a first connector and the second connector, the fitting position guarantee lock comprising:
a second arm whose distal end is flexible in a protrusion direction intersecting the fitting direction;
a fourth locking portion provided at the distal end of the second arm, and configured to, after a third locking portion provided at a distal end of a first arm that is flexible in the protrusion direction of the second connector rides over a first locking portion protruding toward one side in the protrusion direction of the first connector and is engaged with the first locking portion, ride over the third locking portion and be engaged with the third locking portion;
a third arm whose distal end is flexible in the protrusion direction; and
a fifth locking portion provided at the distal end of the third arm, and configured to ride over a second locking portion protruding toward the other side in the protrusion direction of the first connector and to be engaged with the second locking portion at a final locking position where the fourth locking portion rides over the third locking portion and is engaged with the third locking portion.

5. A first connector to be fitted with a second connector to which a fitting position guarantee lock is slidably attached, the first connector comprising
a first locking portion and a second locking portion protruding to both sides in a protrusion direction intersecting a fitting direction of the first connector and the second connector, and configured to be engaged with a locking portion that is provided at a distal end of a flexible arm in the protrusion direction of the fitting position guarantee lock slidably attached to the second connector.
